(19) United States
(12) Patent Application Publication
(10) Pub. No.: US 2006/0175550 A1
(43) Pub. Date: Aug. 10, 2006

(54) Use of a night-vision intensifier for direct visualization by eye of far-red and near-infared fluorescence through an optical microscope

(76) Inventors: Mahmud Ahmad Siddiqi, Silver Spring, MD (US); John David Gearhart, Baltimore, MD (US)

Correspondence Address: EDWARDS & ANGELL, LLP, P.O. BOX 55874, BOSTON, MA, 02205, US

(21) Appl. No.: 10/516,809

(22) PCT Filed: Jun. 6, 2003
(86) PCT No.: PCT/US03/17903

§ 371 Date: Jul. 28, 2005

Related U.S. Application Data
(60) Provisional application No. 60/386,693, filed on Jun. 6, 2002.
(60) Provisional application No. 60/391,520, filed on Jun. 25, 2002.

(51) Int. Cl. G01J 5/00

(52) U.S. Cl. 250/338.1

(57) ABSTRACT

Featured are methods for the direct microscopic visualization of samples (9) using a image intensifier (140) that intensifies low levels of visible light and converts far-red or near-infra-red light to visible light. Also featured are devices and systems for use in the methods of the invention.

### RELATED APPLICATIONS

This application claims the benefit of U.S. Provisional Application Ser. No. 60/386,693, filed Jun. 6, 2002 and U.S. Provisional Application Ser. No. 60/391,520, filed Jun. 25, 2002. The entire contents of each of the above-identified applications are hereby incorporated by reference.

### BACKGROUND OF THE INVENTION

Fluorophores that emit far-red or near-infrared (NIR) light (650-1000 nm), such as Cy5 [Mujumdar, et al. (1993) Bioconjug Chem 4:105-11.], are now widely used in basic biomedical research. This popularity is due to their strong fluorescence, which can be easily separated from that of other common fluorophores, and the absence of far-red and NIR auto fluorescence in many biological materials [Brelje, et al. (1993) Methods Cell Biol 38:97-181; Murphy (2001) Fundamentals of light microscopy and electronic imaging, pg 378. John Wiley & Sons, Inc., New York, N.Y.].

The human eye can typically detect light in the 400-700 nm range. Without prolonged dark adaptation or extremely intense illumination, human vision is relatively insensitive to light at wavelengths longer than 650 nm, and entirely insensitive to light at wavelengths above 700 nm [Inoue and Spring (1997) Video Microscopy: The Fundamentals, pg 741. Plenum Press, New York, N.Y.]. Thus, nearly all far-red and NIR fluorescence emissions are invisible to the human eye. Consequently, Cy5 and similar fluorophores have a significant shortcoming from the viewpoint of the microscopist as they cannot be directly visualized.

Far-red and NIR fluorescence is usually visualized indirectly through charge-coupled device (CCD) or video cameras, often with the further assistance of computerized digital imaging equipment. Despite the broad wavelength sensitivity of CCD and video cameras, which can reach into the infrared spectrum, this indirect approach has several drawbacks. CCD and video cameras typically have limited fields of view compared to the field of view of the microscope to which they are attached. For example, and using the Nikon E800 epifluorescence microscope and Princeton Instruments MicroMax digital CCD camera as illustration, the microscope produces an intermediate image approximately 25 mm in diameter, or about 491 mm². This image can be observed in its entirety through the eyepieces, or observed indirectly using the digital camera. the digital camera, however, has an active imaging area of about 60 mm² thus, at least nine digital frames from the camera are required to match the microscopist's view through the eyepieces. As such, the indirect examination of large individual specimens or large numbers of specimens using a CCD or video camera is impractical and time-consuming.

In addition, CCD and video cameras also may require long exposure or signal integration times in order to produce acceptable images, regardless of wavelength. Long exposure times, however, make it difficult or impossible to observe rapid phenomena in living specimens, or visually scan large regions of interest. Furthermore, long exposure times and a camera's relatively small imaging area can mean that specimens must be exposed to excitation light for extended periods of time. Prolonged illumination by conventional or laser excitation sources is harmful to both living and non-living specimens. For example, light across the visible and NIR spectrum is known to disrupt cellular and developmental processes [Brelje, et al. (1993) Methods Cell Biol 38:97-181; Daniel (1964) Nature 201:316-317; Hirao and Yanagimachi (1978) J Exp Zool 206:365-9; Hegele-Hartung, et al. (1991) Anat Embryol 183:559-71; Potter (1996) Curr Biol 6:1595-8; Hockberger, et al. (1999) Proc Natl Acad Sci USA 96:6255-60; Squirrell, et al. (1999) Nat Biotechnol 17:763-7; Konig (2000) J Microsc 200:83-104; Tirlapur, et al. (2001) Exp Cell Res 263:88-97.]. Also a phenomenon referred to as photobleaching is routinely observed in both fixed and live tissues.

It thus would be desirable to provide a new device, system and methods for direct microscopic visualization of a sample using light intensification techniques. It would be particularly desirable to provide such a device, system and method that would allow direct microscopic visualization of light in the far-red light range, the near-infrared light range and/or the visible light range from a sample. Also, it would be desirable to provide such a device, system and method that would convert a light image of a sample including light that is in a non-visible light range (i.e., light not typically visible to the naked eye), such as the far-red and near-infrared light ranges, into a light image that is visible to the naked eye. It also would be particularly desirable to provide such a device, system and method that would allow direct microscopic visualization of a sample being illuminated by a light source that is being operated at reduced light illumination levels particularly light levels that otherwise would not be observable to the naked eye. Such devices, systems and methods also would be easily adaptable for use with conventional flourescence techniques and microscopic imaging/visualization techniques as well as with conventional microscopic imaging devices used with fluorescence and bright field microscopy, including conventional microscopes.

### SUMMARY OF THE INVENTION

The present invention features a methods for direct microscopic visualization of a sample such as that done during biomedical research, using light intensification techniques. More particularly such methods provide a mechanism for direct microscopic visualization of light in the far-red light range, the near-infrared light range and/or the visible light range. In more particular aspects, such method includes providing a device that converts a light image of the sample, which light image includes or is composed of light that is in a non-visible light range (i.e., light not typically visible to the naked eye), such as the far-red and near-infrared light ranges, into a light image that is visible to the naked eye. In other aspects, the methodology of the present invention includes controlling a light source illuminating the sample so the light output is at a level that reduces/minimizes the potential for biological damage or the like to the sample being illuminated and intensifying the light from the sample so as to produce a light image that is observable to the naked eye. Such methods also advantageously allow a microscopist or user to directly visualize and observe the sample in real time. Such methods also advantageously allow the microscopist to visualize or observe the entire, substantially the entire or a major portion of the intermediate image produced by a microscopic imaging device used in combination with such methods. Moreover, such visualizing or observing can be accomplished in real time by the microscopist.

According to an aspect of the present invention, there is featured a method for microscopic visualization of a sample including intensifying the light emanating from the sample and directly observing a light image provided by the intensified light, more particularly such light intensifying and observing occurs in real time. In an embodiment of the present invention, the method further includes converting light that is emanating from the sample in non-visible light ranges to light that is in the visible light range and wherein said intensifying and observing includes intensifying the converted light and observing the light image provided by the converted intensified light.

In another embodiment, such a method further includes providing a image converter that is configured and arranged so as to intensify the light received at an input end and providing an image at an output end. In addition, the method includes locating the image converter in the optical light path between the sample and the microscopist such that the light from the sample is received at the image converter input end. In more particular embodiments, the image converter is located so that an input face of a light intensifying device is proximal to the intermediate image plane of the microscopic imaging device (e.g. the intermediate image plane of the microscope).

In further embodiments, the method includes providing a plurality of the image converters that are located in the optical light path so as to provide a stereoscopic image. More particularly, the plurality of the image converter is arranged so as to allow binocular vision. As is known in the art, binocular or stereoscopic vision preserves depth perception and allows the methodology of the present invention to be used in combination with dissection and/or micromanipulation techniques. In contrast, obtaining stereoscopic vision is extremely difficult to reproduce using conventional indirect visualization approaches or techniques.

In further embodiments, the image converter is configured and arranged such that light being received at the input end that is in a non-visible light range is converted so as to provide a light image that is in the visible light range at the output end thereof. In more particular embodiment, the image converter is configured and arranged to convert light in the far-red light range or near-infrared light range into a visible light image at the output end thereof. In additional particular embodiments, the image converter intensifies one of the converted light or the light in the non-visible light range.

In an exemplary embodiment, the image converter includes a night-vision optical device that is sensitive to light in the wavelength range of interest and converts image is made up of low levels of visible light or near-infrared light (light in non-visible range) focused on its input face to images that can be directly visualized that the output face thereof. In further exemplary embodiments, the image converter includes a housing inside which is located the night-vision optical device, which housing is configured and arranged to the couple the image converter to the microscopic imaging device and to minimize external stray light from being observed that the input face of the night-vision optical device.

Also featured are a systems and devices embodying and/or for use in implementing such methodology.

Other aspects, embodiments, features and advantages of the invention will be apparent from the following detailed description and claims.

### BRIEF DESCRIPTION OF THE DRAWINGS

FIGS. 1A,B are schematic block diagrams illustrating microscopic visualtization systems according to the present invention with a monocular eyepiece (1A) and a binocular eyepiece (1B).

FIG. 2A is schematic view generally illustrative of the basic elements of a microscope.

FIGS. 2B,C are schematic views illustrating placement of a visual converter according to the present invention at the intermediate image plane of the microscope (2B) and at a re-positioned intermediate image plane (2C).

FIG. 3 is a schematic cross-sectional view of a visual converter according to the present invention.

FIG. 4A is a cross-sectional view of a shell for a housing according to an embodiment of the present invention.

FIGS. 4B, D are bottom and cross-sectional views respectively and of a cap for a housing according to an embodiment of the present invention.

FIG. 4C is a top view of the shell of FIG. 4A.

FIG. 5 depicts the Visualization of Far-Red and Near-infrared Fluorescence. Human GFP-EBD cells were stained with the indicated fluorescent dyes and visualized by epifluorescence on a Nikon TE200 inverted microscope through standard eyepieces (By Eye) or through the NIRIC. Cells are also shown by Hoffman Modulation Contrast microscopy (IMC, transmitted light) as seen through standard eyepieces. A 60×, NA 0.70 HMC objective was used, final magnification for all images is 150×. HO, Hoechst 33258; GFP, green fluorescent protein; Mito, MitoTracker Red CM-H₂XRos; NIR, near-infrared; LP, longpass; nm, nanometers. Emission wavelengths imaged for each fluorophore are indicated. The NIRIC detects blue fluorescence at the lower limit of its spectral range, and produces amplified images in green and red. Far-red and NIR fluorescence is not visible by eye, but can be clearly seen through the NIRIC. An essentially complete absence of background fluorescence in NIRIC images was noted in the far-red and NIR.

FIGS. 6A-6C depicts the Visual Scanning of Tissue Sections. Using the NIRIC, tissue sections were screened for the presence of DiR-labeled cells on the E800 microscope (epifluorescence, 780 nm longpass) using a 10×, NA 0.30 phase objective. Dashed white lines indicate the edges of the tissue section. (A) DiR-positive cells were easily seen with the NIRIC (final magnification 10×), and large tissue sections could be quickly surveyed by eye in real time. Box indicates the area shown in B. (b) Grid overlay (red) indicates 25 individual frames captured by a MicroMax CCD camera with a 20×, NA 0.50 phase objective (final magnification 20×; the CCD camera failed to detect positive cells using the 10× objective, even with long exposure times). Only one frame, outlined in red, shows DiR-positive cells. Most of the CCD frames are empty, and more than 35 frames would be required to image the area encompassed by the NIRIC at lower magnification. (C, D) The highlighted frame in B, showing DiR-positive cells by epifluorescence (C) and DIC microscopy (D) as captured with the MicroMax CCD camera (final magnification 20×).

FIGS. 7A-7B depict the Visualization of Embryos in Low Light. Mouse embryos were imaged on the TE200 microscope using a 40×, NA 0.60 Hoffman Modulation Contrast objective (transmitted light, final magnification 100×). (A) With the aid of the NRIC, embryos were visible at illumination levels too low to allow visualization through standard microscope eyepieces. (B) At higher illumination levels the embryos were visible by eye through the microscope's standard eyepieces, as photographed with the U-III camera (Kodak ELITE Chrome 35 mm slide film). A slight degradation of image quality with the NIRIC in this brightfield application was observed (compare images at top and bottom arrows).

FIGS. 8A-8C depict epifluorescence microscopy with limited excitation light using a microscopic array of fluorescent beads immobilized in sucrose, which was constructed by micromanipulation. (A) A 20×, NA 0.50 objective was used to observe the array on the E800 microscope (final magnification for all images is 50×). A portion of the bead standard array as seen by eye through standard eyepieces (and photographed with the U-III camera), showing all beads by Nomarksi Differential Interference Contrast microscopy (DIC) and their corresponding epifluorescence in green (FITC filters). Relative fluorescence intensities for the beads in green (FITC filters) and red (TRITC filters) are indicated. (A, B, C) Bead 8 is unlabeled (no fluorochromes); intensities are relative to the background fluorescence of Bead 8. Dark arrowheads indicate visible array lines, open arrowheads mark the location of array lines not visible to observers. (B) Lines of the bead standard array visible with FITC filters at decreasing levels of epifluorescence illumination, through normal microscope eyepieces (By Eye) and the NIRIC. (C) Lines of the bead standard array visible with TRITC filters at decreasing levels of epifluorescence illumination, through normal microscope eyepieces (By Eye) and the NIRIC. (B, C) Illumination from a 100 watt mercury arc lamp was attenuated with neutral density filters. ND, neutral density; ND1, full illumination; ND10, 10% transmission (i.e. 1/10^{th} of the full illumination intensity); ND100, 1% transmission. Note halo and other artifacting of bright beads with the NIRIC under strong illumination.

FIGS. 9A-9B depict the direct visualization of Cy5 signals in FISH. Metaphase chromosomes were prepared for fluorescence in situ hybridization (FISH). Fluorescent signals were imaged on the E800 microscope, final magnification 250×. (9A) Upper panels: Enhanced visibility of dim FITC signals seen with the NIRIC as compared to standard eyepieces (By Eye). Lower panels: Chromosomes counterstained with DAPI. (9B) Upper panels: Cy5 signals invisible through standard eyepieces (By Eye) are directly visualized with the NIRIC. Arrowheads highlight chromosomes hybridizing with Cy5-labeled probe. Lower panels: Chromosomes counterstained with DAPI.

### DETAILED DESCRIPTION OF THE INVENTION

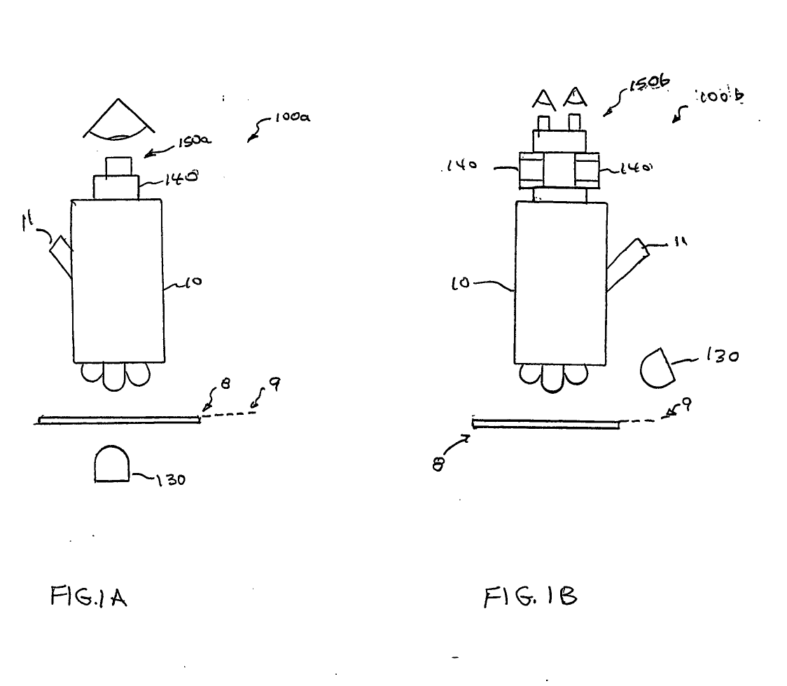

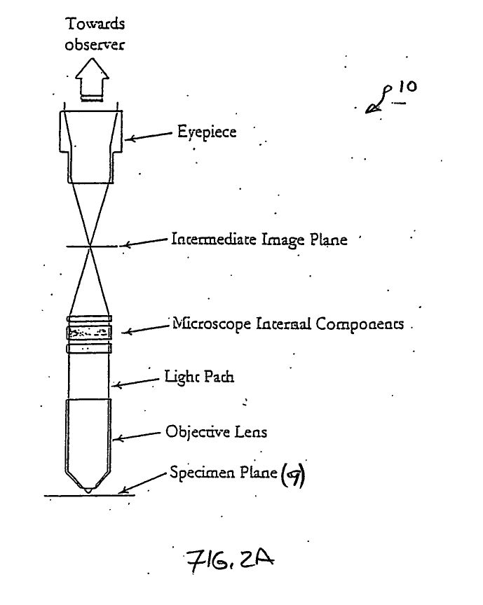

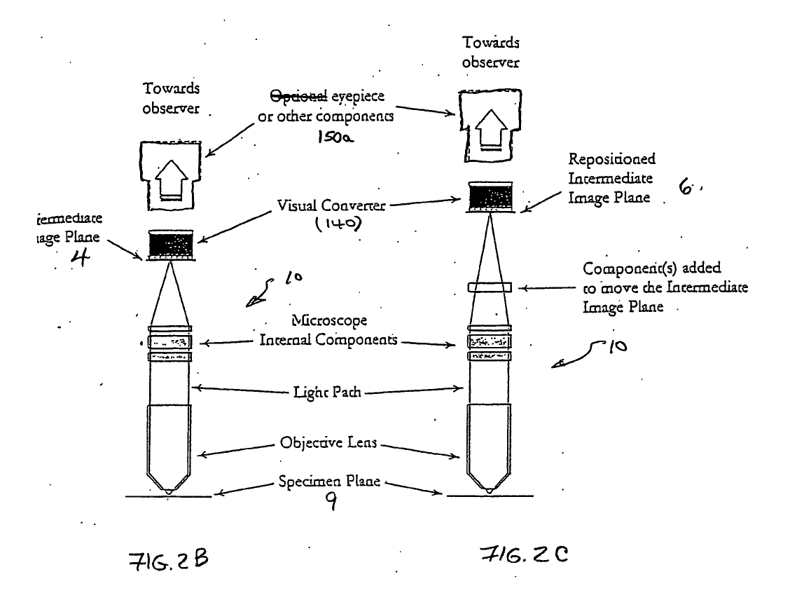

Referring now to the various figures of the drawing wherein like reference characters refer to like parts, there is shown in FIGS. 1A,B schematic block diagrams illustrating microscopic visualization systems 100a,b according to the present invention. Reference also is made to FIGS. 2A-C which are schematic views of the basic elements of a conventional microscopic imaging device 10 such as a microscope (FIG. 2A) and schematic views illustrating placement of a visual converter 140 (also referred to interchangeably herein as an “image converter”) according to the present invention at the intermediate image plane 04 of the microscopic imaging device 10 or microscope (FIG. 2B) and at a re-positioned intermediate image plane 06 of the microscopic imaging device (FIG. 2C). Each of the illustrated microscopes/microscopic imaging devices 10 are positioned so as to view a sample or specimen 8 that is located at the specimen plane 9. The specimen is illuminated by a light source 130. The light source 130 is any of a number of light sources known to those of skill in the art by which a user can illuminate a specimen or sample using a microscope/microscopic imaging device.

There is shown in FIG. 1A, a microscopic visualization system 100a that includes a microscopic imaging device 10, a visual converter 140 according to the present invention and a light source 130. The microscopic imaging device is any of a number of devices or apparatuses known to those skilled in the art by which a user can directly and/or indirectly observe the specimen including but not limited to conventional microscopes as well as those configured and arranged to allow direct visualization and indirect visualization and/or acquisition of a permanent record (e.g., picture, digital images, video images). Such microscopic imaging devices also includes those intended for use in both fluorescence and low light level brightfield microscopy.

The visual converter 140 is operably and optically coupled to the microscopic imaging device using any of a number of techniques known to those skilled in the art such that light from the specimen 8 is coupled to the proximal or front end 142 and so that the distal or back end 144 of the visual converter is towards the observer. The mechanism for operably and optically coupling also preferably provides a mechanism to minimize or eliminate the potential for stray external light to enter into the visual converter 140 via the front end 142 thereof.

In further embodiments, the visual converter back end 144 is configured and arranged so as to include one or more optical elements 146a as is known to those skilled in the art so as to further magnify the image being outputted by the visual converter 140. In a particular illustrative embodiment, the microscopic visualization system includes a monocular eyepiece 150a as is known to those skilled in the art and the visual converter back end 144 is configured and arranged so the monocular eyepiece 150a is operably and optically coupled to the visual converter back end. The eyepiece 150a provides a mechanism by which the image being outputted by the visual converter 140 can be magnified by the user. Preferably, the visual converter back end 144 is configured and arranged such that the monocular eyepiece is removable so a user can easily adjust the amount of magnification.

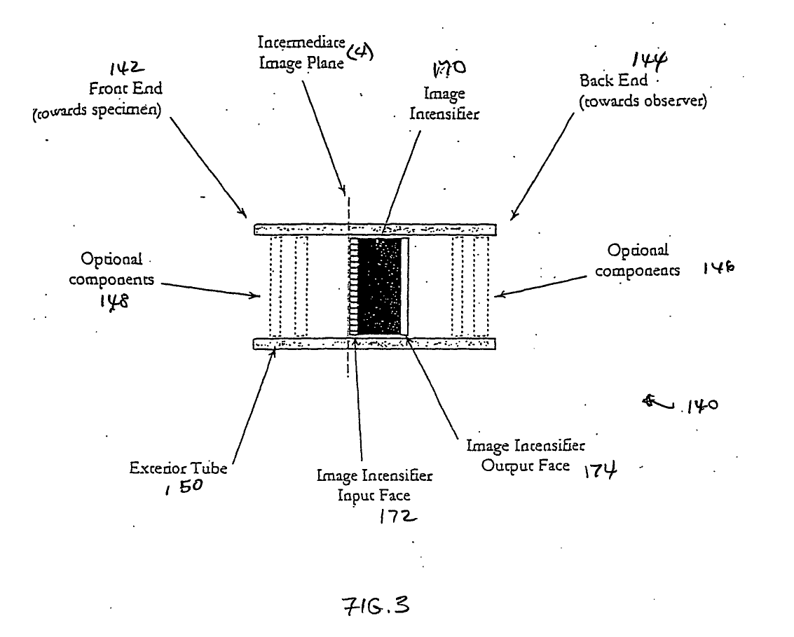

Referring now also to FIG. 3 is a schematic cross-sectional view of a visual converter according to the present invention, which includes a housing 150 and a light intensification device 170 or light intensification tube. The light intensification device 170 is arranged within the housing 150 so that an input face 172 of the image intensification device is towards the specimen when the visual converter 140 is operably coupled to the microscopic imaging device 10 and so an output face 174 thereof is arranged towards the observer, viewer or user.

The light intensification device is any of a number of light intensification devices known in the art, more particularly devices that also are capable of sensing light that lies outside the visible range and can generate or provide an image that lies within the visible range of the light that is outside the visible range. In more specific embodiments, the light intensification device is any of a number of conventional night vision tubes or devices. Modern night vision equipment is based on gallium arsenide (GaAs) image intensifier tubes, which convert a wide spectrum of incident light into an amplified stream of electrons that is accelerated onto a phosphor screen, which then emits visible light. The principles of operation of these types of image intensifiers are further detailed by Inoue and Spring ((1997) Video Microscopy: The Fundamentals, pg 741. Plenum Press, New York, N.Y.). In an illustrative exemplary embodiment, the light intensification device is a FS9925D intensifier tube as manufactured by ITT Industries, having input and output faces that are 25 mm in diameter. The intensifier is powered by 3 volts DC, such as that which can be provided by two AA batteries, and is sensitive to light from about 450 to 900 nm.

The housing 150 also is configured and arranged so that light that makes up the intermediate image is passed through the front end 142 to the light intensification device input face 172 and so that the image provided at the image intensification device output face is observable from the back end 144. In more specific embodiments, and as indicated herein, the end of the housing 150 corresponding to the visual converter front end 142 is configured and arranged so as to operably and optically couple the visual converter 140 to the microscopic imaging device. Such coupling includes mechanical coupling via a screw type connection, a slide fit connection or other any other mechanical connecting techniques know to those skilled in the art.

In addition, the housing is constructed so as to secure the intensification device 170 within the housing so as to generally maintain the input face 172 thereof in fixed relation with respect to the converter front end 142. In more particular embodiments, the housing 150 is constructed and arranged such that the input face 172 is disposed at, about or proximal the intermediate image plane 4 of the microscopic imaging device 10.

In further embodiments, the housing s constructed of materials that are opaque to the light wavelengths or frequencies of use and sized so as to sufficient mechanical strength for the intended use. Such materials include, but are not limited to, metals such as aluminum and plastics.

Now with reference to FIG. 2C, the visual converter 140 further may include one or more optical elements 148 as is known to those skilled in the art by which the intermediate image plane can be repositioned. In this way, a user can adjust the position of the intermediate image plane to optimize it for a given application and for the construction and arrangement of a given visual converter. For example, a particular visual converter might be constructed in such a way that the input face would not be proximal to the intermediate image plane of a particular microscopic imaging device. Thus, the additional optical components 148 can be utilized so as to reposition the intermediate plane so that it is at, about or proximal the input face.

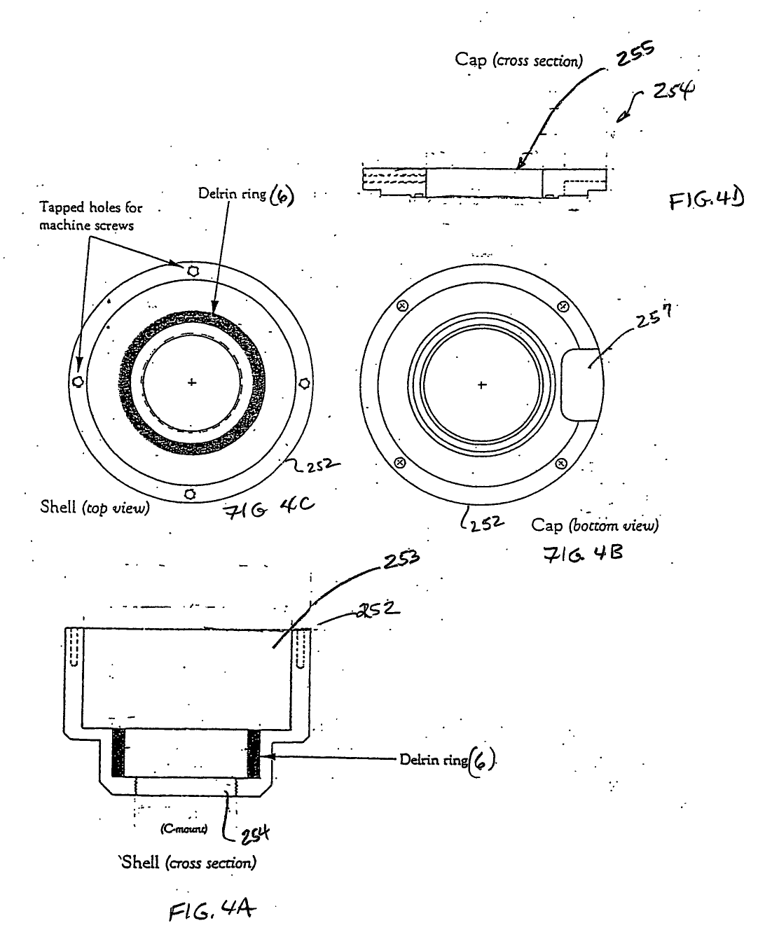

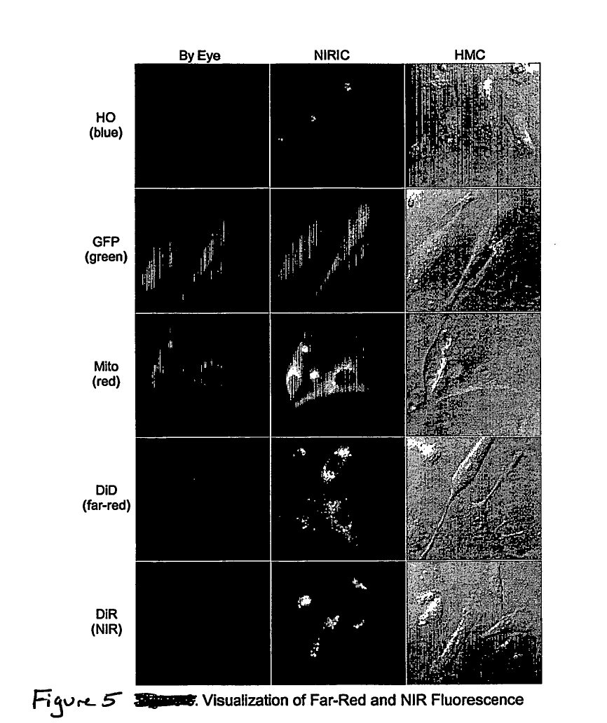

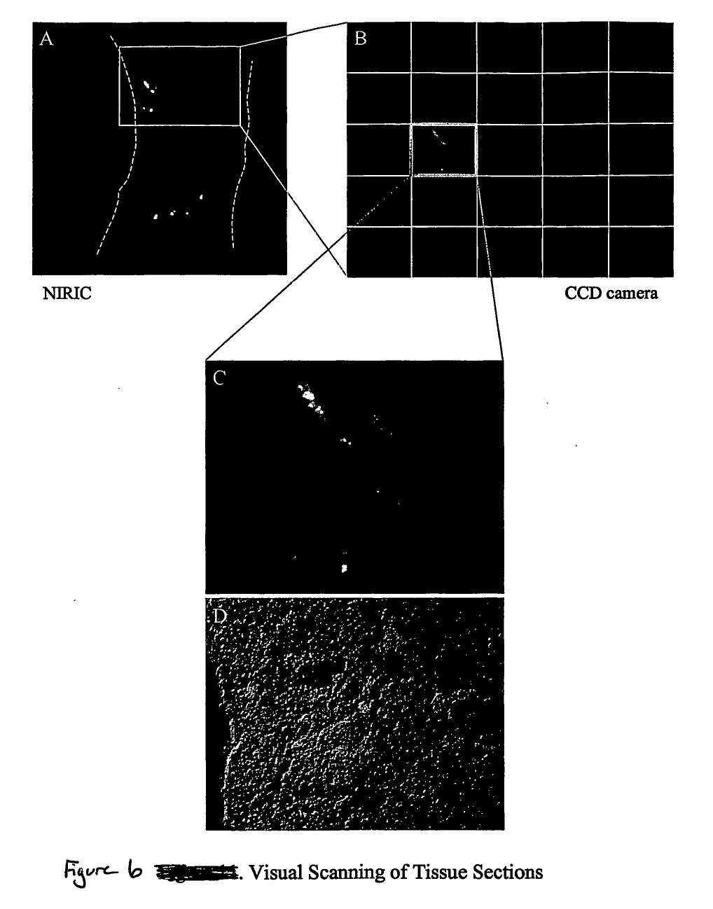

Referring now to FIGS. 4A-D, there is shown a particularly illustrative embodiment of a housing for a visual converter 140 according to the present invention. In the illustrated embodiment, the housing includes a shell 252, a cap 254, and a compression washer (not shown). An image intensification device 170 is disposed within an interior compartment 253 of the shell 252 so image intensification device input face 172 is positioned so as to face the front end through aperture 254. In addition, the housing further includes a ring 256, such as a delrin ring, that blocks stray reflected light and forms a seating surface for the input face 172.

The cap 254 is secured to the back end of the housing shell 252 using any of a number of techniques known to those skilled in that art. In an illustrative embodiment, the cap 254 is secured to the shell by screws. The compression washer in combination with the cap 254 provides a mechanism for securing the image intensification device 170 within the shell interior compartment 253. The cap 254 also is configured and arranged so as to include a through aperture 255 in which is received the monocular eyepiece 150a. In further embodiments, the cap 254 includes a notch 257 therein, through which power leads for the image intensification device can be routed.

Referring now to FIG. 1B, there is shown a microscopic visualization system 100b that includes a microscopic imaging device 10, a plurality of visual converters 140 and a light source 130. Reference shall be made to the foregoing discussion for FIG. 1A as to the details of the microscopic imaging device 10, the visual converter 140 and the light source 130. In the illustrated embodiment, the microscopic visualization system 100b is particularly configured for use with a microscopic imaging device configured to provide binocular or stereoscopic vision/images. In this embodiment, a visual converter is disposed in each of the optical paths operabally and optically coupled to the binocular eyepieces 150b, or to two separate eyepieces configured or arranged to provide stereoscopic or binocular viewing.

As is illustrated in either of FIGS. 1A,B the microscopic visualization system 100a,b can include a microscopic imaging device 10 that is configured and arranged so as to have an additional optical port 11 that is optically coupled so as to also view the specimen 8 at the same time the specimen is being directly visualized by the user or microscopist. In this way, the microscopist can utilize the one or more other optical ports 11 for indirect visualization of the specimen as well as for obtaining digital, film or video images or at least portions of the specimen being visualized. For example, a microscopist can directly visualize the intermediate image in its entirety, identifying those areas of the intermediate image for digital imaging and acquiring digital images for these specific areas. This should be less costly and less time consuming as compared to conventional indirect imaging techniques in which large number of digital images are acquired to incrementally image the entire intermediate image.

The methodology of the present invention can be best understood from the following discussion and reference to the systems 100a,b and visual converters described herein and shown in FIGS. 1-4. More particularly the following.

First is described a method for visualization of far-red and near-infrared (NIR) emitting fluorophores, more particularly visualization of far-red and NIR emitting fluorophores by the need to localize small numbers of Cy5-labeled cells in large tissue sections. The Cy5 label is chosen to avoid visible spectrum autofluorescence in the sections. A possible solution, based on the use of sub-optimal excitation and emission filter sets that focus on the visible portion of Cy5 fluorescence, has been proposed [Ferri, et al. (2000) J Histochem Cytochem 48:437-44]. However, this approach cannot be applied if the Cy5 signal must be separated from fluorescence or autofluorescence in the orange-red region of the spectrum, and cannot be applied to other fluorophores with little or no emission in the visible spectrum. A variety of fluorophores in addition to Cy5 emit light at wavelengths longer than 700 nm [Haugland (2001) Handbook of Fluorescent Probes and Research Chemicals, 8^{th} Edition], and have therefore been useless in studies that require visual observation. A general method for the direct visualization by eye of far-red and NIR fluorescence would allow the use of these fluorophores in virtually any fluorescence technique.

The direct visualization methodology of the present invention for visualization of far-red and NIR fluorescence is advantageous in the following respects: The method is broadly applicable, and not specific to any particular fluorophore, fluorescence technique, or microscope and allows real-time observation and visual scanning, with the largest possible field of view (FOV). Also, the method is particular suitable for direct observation or eye viewing, and can be used in combination with existing photodocumentation, such as digital imaging using CCD cameras and/or far-red and infrared sensitive photographic photography. Moreover, the method and devices used therewith are easily adaptable for use with an existing microscope, and within established experimental procedures or techniques (i.e., substantive procedural modifications should not be required).

As indicated herein, the difficulty in visualizing long-wavelength fluorescence is due to the physiological limitations of the human eye, not the microscope per se and thus any attempt to make long wavelength fluorescence directly observable to the human eye must address this fundamental restriction of human physiology. Accordingly, the methodology of the present invention contemplates converting a microscope intermediate image composed of invisible long wavelength light to an image made up of light in the visible spectrum. A particular mechanism contemplated for use in or for accomplishing this conversion process are most the electro-optical devices of the type found in ‘night vision’ equipment, which has been widely used in military applications. Modern night vision equipment is based on gallium arsenide (GaAs) image intensifier tubes, which convert a wide spectrum of incident light into an amplified stream of electrons that is accelerated onto a phosphor screen, which then emits visible light.

In further embodiments, the method includes bringing the intermediate image of the microscope/microscopic imaging device 10 to focus on a visual converter 140 containing an image intensifying device 170. The image intensifying device 170 typically is highly sensitive to a broad range of light wavelengths, including but not limited to near-infrared light, far-red and extremely low levels of visible light which are invisible to the human eye. The image intensifying device 170 converts the invisible intermediate image (image composed of light outside the visible range) into an image easily visible to the human eye. The resulting image may be viewed through the visual converter with or without additional magnification, such as that provided by a standard microscope eyepiece 150a.

Extremely low levels of visible light (about 400 to about 700 nm) and near-infrared light (about 700 to about 1200 nm) are invisible to the human eye and an observer cannot directly view images made up of these types of light. Thus, direct visual examination of specimens through an optical microscope is not possible if the specimen is illuminated by or emits low levels of visible light, or near-infrared light. Visual examination of photosensitive or thermally sensitive specimens, such as live cells and tissues, or reactive or fluorescent materials, is extremely difficult when the level of light required for direct visual observations will heat, damage, destroy, or otherwise affect those specimens. Visual examination of specimens (or features within specimens) that transmit, reflect or emit near-infrared light, such as long wavelength fluorophores used in many clinical, diagnostic, and experimental fluorescence techniques, also is not possible since this light is invisible to the human eye. As further described herein. The methods of the present invention overcome such shortcomings and allow such specimens to be directly visualized by the human eye in real-time, without the need for significant modifications to optical equipment, techniques, or procedures, and without the need for modifications to established clinical, diagnostic, or experimental techniques.

As indicated herein, image intensification for the purpose of direct visualization by eye of images made up of low levels of visible light or near-infrared light has not previously been applied to optical microscopy. Currently, such images are viewed indirectly with the aid of charge coupled devices (CCDs) or video cameras; these indirect approaches have several shortcomings. CCD and video cameras have limited fields of view when compared to the field of view of the microscope to which they are attached. This limitation makes the examination of large individual specimens or large numbers of specimens through the optical microscope impractical and time-consuming. In addition, CCD and video cameras may require long exposure or signal integration times in order to produce an acceptable indirectly viewed image. This requirement also makes examination of large numbers of specimens difficult or impractical, and prevents real-time observation through the microscope. As described herein, the methods of the present invention make possible the direct, real-time viewing by eye of normally invisible images, using up to the full field of view of the optical microscope to which it is applied. When appropriately applied, the method easily and simply allows binocular (stereoscopic) vision, which preserves depth perception in techniques such as dissection and micromanipulation; stereoscopic vision is extremely difficult to reproduce by indirect visualization approaches.

In particular embodiments, a visualization method according to the present invention can be applied to any microscope that produces a real intermediate image. Such a method includes determining the location of the intermediate image plane of the microscope to which the method will be applied and making the intermediate image plane of the microscope physically accessible. In one embodiment, this can be accomplished by removal of one or more microscope eyepieces. In further embodiments, such a method further includes bringing the intermediate image into focus on a visual converter (described elsewhere herein) constructed to allow the visualization by eye of the images or wavelengths of light of interest. This step can further included placing the visual converter at the intermediate image plane (e.g., see FIG. 2B), or moving or repositioning the intermediate image plane to a conveniently positioned or mounted visual converter. As indicated herein, such re-positioning can be accomplished by use of additional components 1, including but not limited to lenses, fiber optics, or image relay systems, depending on the configuration of the microscope or microscopic imaging device 10 be used in combination with the visual converter 140.

As to the preparation of the specimens to be viewed, examined or observed, such specimens are prepared normally in all respects using standard methods known to those of skill in the art. The modified microscope is operated normally in all respects, except that the intermediate image may be viewed through the visual converter 140, which will allow the direct visualization of images not normally perceptible by eye. Images rendered visible by the visual converter 140 may be viewed with magnification (such as that provided by the original microscope eyepiece) using additional lenses or components.

The following describes one exemplary use of the methodology and visual converter 140 of the present invention with a Nikon E800 microscope (described in further detail herein). The image intensifier comprising the image intensifying device 170 is an ITT Industries FS9925 series intensifier, with input and output faces 25 mm in diameter. The intensifier is powered by 3 volts DC, provided by two AA batteries, and is sensitive to light from about 450 to 900 nm.

The intermediate image of Nikon E800 microscope microscope is 25 mm in diameter, and the microscope was rendered accessible by removal of one eyepiece and eyepiece tube. The intermediate image was brought to focus on the input face 172 of the image intensifier by placement of the visual converter 140 at the intermediate image plane 4 (FIG. 2B). The microscope can be operated normally, with the addition that intermediate images of specimens of interest may be viewed through the visual converter 140. This application of the method of the present invention renders images produced by epifluorescence microscopy utilizing the Fluorophores Cy5, DiD, and DiR, which are normally invisible to the naked eye, easily visible.

The following describes another exemplary use of the methodology and visual converter 140 of the present invention with an Olympus SZH10 stereomicroscope. The intermediate image of the Olympus SZH10 stereomicroscope was rendered accessible by removal of one or both eyepieces. The visual converter is constructed with a housing 150 dimensioned such that the front end thereof can be directly inserted into the microscope's eyepiece tube in place of a previously removed eyepiece. The intermediate image was brought to focus on the input face 172 of the image intensifier within the visual converter 140 by placement of an appropriate lens or lenses 148 at the front end of the visual converter housing 150 as illustrated schematically in FIG. 3. The converted intermediate image can be viewed with the aid of magnifying lenses 146 placed at the back end of the visual converter housing 150. The microscope can be operated normally, with the addition that intermediate images of specimens of interest may be viewed through the visual converter 140. In order to preserve stereoscopic vision through the microscope, the method is applied to both the left and right optical paths, i.e. with the removal of both the left and right eyepieces and the use of two visual converters such as that illustrated schematically in FIG. 1B. Thus, no other steps are required to preserve stereoscopic vision.

The methods of the present invention are adaptable for use with any microscope that produces a real intermediate image, including, but not limited to, focal length, infinity-corrected, compound, epifluorescence, polarization, brightfield, darkfield, phase, interference or modulation contrast, upright, inverted, and stereomicroscopes with monocular or binocular eyepieces. The visual converter described may be interchanged for a standard microscope eyepiece or may be permanently or temporarily mounted to the microscope. The method will result in the conversion of images made up of near-infrared or extremely dim visible light into full field, real-time images that are easily visible by eye, allowing rapid visual scanning of a wide variety of specimens.

For the purposes of fluorescence microscopy, the method of the present invention is adaptable and contemplated for used in the direct visualization by eye of fluorophores that emit light in the near-infrared spectrum, such fluorophores include but not limited to Cy5, Alexa 647, and DiR. See also the further examples in Table 1 below:

TABLE I

| | Emission | |
|---|---|---|
| Fluorphore | Maxima (nm) | Specificity |
| TOTO-3 | 660 | DNA dye |
| TO-PRO-5 | 770 | DNA dye |
| LDS 751 | 712 | DNA dye |
| Alexa Fluor 680 | 707 | (Various conjugates) |
| MitoFluor Far | 710 | Mitochondrial stain |
| Red 680 | | |
| FM 4-64 | 734 | Lipophilic dye |
| DiD | 665 | Lipophilic dye |
| DiR | 780 | Lipophilic dye |
| Carboxynaph- | 668 | pH indicator dye |
| thofluorescein | | |
| RH 237 | 782 | Membrane potential probe |

(see Haugland, R. P. (2001). Handbook of Fluorescent Probes and Research Chemicals.)

The method of the present invention also are contemplated for use in instances where the visualization of near-infrared light is necessary, including but not limited to efforts to avoid background fluorescence or autofluorescence, or to provide spectrally distinct signals in schemes requiring multiple fluorescence colors, such as Fluorescent In Situ Hybridization (FISH), Comparative Genomic Hybridization (CGH), microarray hybridization, or multicolor labeling using antibodies or dyes. The method of the present invention also is contemplated for use and adaptable to view extremely dim images made up of light in the visible spectrum, including but not limited to instances when the fluorescent signal is extremely weak, or when the fluorescence emission is reduced because the energy of excitation light is or has been limited in order to avoid damage, heating, or other deleterious effects to the specimen(s) of interest.

In the case of transmitted or reflected light microscopy, the method of the present invention will allow viewing of dim visible spectrum images, including but not limited to those produced by polarized light, or instances where illumination is weak or has been reduced in order to avoid damage, heating, or other deleterious effects to the specimen(s) of interest. The method of the present invention also is contemplated for use in schemes in which illumination is achieved using only near-infrared light, such as transmitted or reflected near-infrared microscopy.

The method of the present invention also is adptable for use in the ultraviolet or infrared (thermal) spectra by a modification of the spectral sensitivity of the image intensifier in the visual converter 140 or use of an image intensification device particularly suited for sensing light in the desired range of wavelengths. The method of the present invention also is adatable for use with images of varying brightness by adjustment of the sensitivity of the image intensifier. The method of the present invention also is adpatable and contemplated for use to simultaneously display multiple spectrally distinct colors to the viewer by the addition of bandpass filters to the visual converter 140, in a manner analogous to multiple color fluorescence microscopy using multiple bandpass filters.

The methods, device and systems of the present invention are further illustrated by way of the following examples, which should not be construed as limiting. The contents of all references, patents, and published patent applications cited throughout this application, as well as the sequence listing and the figures, are incorporated herein by reference.

### EXAMPLES

Materials and Methods

Image Intensifier

A model FS9925D image intensifier tube and power supply were obtained from ITT Industries Night Vision (Roanoke, Va.). The FS9925D is a Generation 3 gallium arsenide photocathode-based, proximity-focused, non-inverting image intensifier with flat fiber optic input and output phosphor windows 25 mm in diameter. The intensifier tube has spectral sensitivity from approximately 450 to 900 nm (sensitivity increases with wavelength), and high spatial resolution (the unit used in the present work was capable of resolving 64 line pairs/mm, which corresponds to a pixel size of approximately 8 μm). Nominal tube specifications are as follows: Visual quality—no spots larger than 0.003 inch. At 900 volts, the photocathode sensitivity is 2509 mA/lumen (luminous, 2856° K) and 147 mA/Watt (radiant, 880 nm). The microchannel plate voltage (40,000×Gain) is 926 volts, and the clamp voltage is 35 volts. The maximum operating voltages are: photocathode to microchannel plate: 920 volts; microchannel plate to output: 1200 volts; and microchannel plate output to screen: 4200 volts.

Three (3) volts DC current was supplied to the intensifier power supply from two ‘C’ batteries in series, operated by a simple on/off switch. Wire leads to the intensifier were extended at the factory by approximately one meter to allow convenient remote placement of the switch, batteries, and power supply. The intensifier gain was also factory preset to 40,000 fold. In operation, the intensifier converts incident light within its operating spectral range at its input face into green light emitted at its output phosphor face without spatial distortion.

Hardware

A housing comprised of a two-part shell (shell proper and cap) was constructed to house the intensifier tube. The shell protects the intensifier tube, blocks stray light, allows a magnifying eyepiece to be placed at the intensifier output window, and facilitates the coupling of the intensifier to a microscope. The shell is open at the bottom to allow incident light to reach the intensifier input optic and at the cap to allow viewing of the output phosphor. The intensifier tube fits inside the shell such that its input optic faces the bottom opening, and is held in place by the cap with the aid of a compression washer. The intensifier output phosphor is visible through the opening in the cap. The cap was also slotted to allow passage of the intensifier power leads.

The body of an Olympus WH1 Ox-H/22 focusing eyepiece was shortened such that when the eyepiece is appropriately placed at the shell cap the intensifier output window lies at the eyepiece reticle landing (i.e., at the normal location of the microscope intermediate image). For flexibility in coupling to various microscopes, the opening at the bottom of the shell was dimensioned and threaded as a standard female C-mount, but was not used in this manner for the present work. The assembled prototype—shell, intensifier tube, cap, and eyepiece—is referred to alternately herein as the “near-infrared image converter”, or “NIRIC”. It should be noted that the general term “image converter” is interchangeable herein wit the term “visual converter”.

Due to its size, the NIRIC could not be practically mounted on a microscope in the most logical manner as a modular replacement eyepiece. However, the NIRIC could be used as a ‘third eyepiece’ when placed at the camera port of a microscope's trinocular head. In this configuration, all three eyepieces provide equivalent views to an observer: The microscope intermediate image can be viewed at 10× magnification through the microscope's standard eyepieces, while the NIRIC conducts the intermediate image focused onto its input window without magnification to the output window, which is also viewed through a 10× eyepiece. A parfocalizable coupler that fit the camera ports of the two Nikon microscopes used here (see below) was made for the NIRIC, and used throughout the work described.

Microscopes

Two infinity-corrected Nikon Eclipse epifluorescence microscopes (CFI60 optics) served as a platform for the NIRIC—an E800 (upright) and a TE200 (inverted). Both microscopes use 100-watt mercury arc lamps (Ushio USH-102D) as fluorescence excitation sources, and 12-volt, 100-watt tungsten bulbs as illumination for brightfield and transmitted light techniques. Both microscopes were equipped with trinocular image heads (eyepieces and one camera port), and beamsplitters to direct images to secondary camera ports. The E800 was equipped for phase and Nomarski differential interference contrast (DIC) microscopy. The TE200 was equipped for Hoffman Modulation Contrast (HMC) microscopy using extra-long working distance (ELWD) objectives. During testing, no modifications were made to either microscope, and no efforts were made to replace objectives in order to improve light throughput to the NIRIC, i.e., objectives incorporating phase rings or modulator plates were not replaced with objectives without such modifications. Further details of the E800 and TE200 microscopes are provided below in Table 2:

TABLE 2

| | E800 | TE200 |
|---|---|---|
| General | Upright, infinity- | Inverted, infinity- |
| | corrected, CFI60 | corrected, |
| | optics, phase, DIC, | CFI60 optics, HMC, |
| | epifluorescence; | epifluorescence; |
| | trinocular | trinocular erect |
| | image head | image head |
| Camera Ports | Front and Rear | Front and Side |
| Beamsplitters | Front 100% eyepieces | Front 100% eyepieces |
| | 80%/20% | 80%/20% |
| | camera/eyepieces | camera/eyepieces |
| | 100% camera | 100% camera |
| | Rear: 100% front | Side: 100% front |
| | beamsplitter | beamsplitter |
| | 100% camera | 80%/20% camera/front |
| | | beamsplitter |
| Eyepieces | CFIUW 10×/25 | CFIW 10×/22 |
| Condenser | NA 0.90 dry | NA 0.60, HMC ELWD G3, |
| | | 40 mm working distance |
| Objectives | 10×/.30 (PF, | 4×/.13 (PF,PhL) |
| Magnification/NA | Ph1, DIC M) | 10×/.30 (PF, HMC, ELWD) |
| | 20×/.50 (PF, | 20×/.45 (PF, HMC, ELWD, |
| | Ph1, DIC M) | corr) |
| | 100×/1.4 (oil, | 40×/.60 (PF, HMC, ELWD, |
| | PA, DIC H) | corr) |
| | | 60×/.70 (PF, HMC, ELWD, |
| | | corr) |
| Transmitted | 12 Volt, 100 Watt | 12 Volt, 100 Watt |
| Light Source | tungsten bulb | tungsten bulb |
| Fluorescence | 100 Watt mercury | 100 Watt mercury arc lamp |
| Excitation Source | arc lamp (Ushio | (Ushio USH-102D) |
| | USH-102D) | |
| Notes | Five fluorescence | Four fluorescence filter |
| | filter cubes, | cubes |
| | neutral density | |
| | filters to | |
| | attenuate | |
| | fluorescence source | |

PF, PlanFluor,
PA, PlanApo;
NA, numerical aperture;
Ph, phase;
DIC, Nomarski Differential Interference Contrast;
HMC, Hoffman Modulation Contrast;
ELWD, extra-long working distance;
corr, correction collar.

Optical Filters

Fluorescence filter sets were obtained from Nikon (via Inage Systems) or Chroma Technology (Brattleboro, Vt.). The E800 and TE200 microscopes use the same epifluorescence filter cubes. Filters covering emission wavelengths from blue to far-red (DAPI, GFP, TRITC, Cy5) were generally available standard sets known to those skilled in the art. For NIR fluorescence emissions we used a custom set designated 780DCXR, made by Chroma (excitation filter 667-742 nm, dichroic mirror 780 nm, emission filter 780 nm long pass). Neutral density (ND) filters were obtained from Chroma; ND values are referred to herein using Nikon's nomenclature, as follows: ND1=100% transmission, ND10=10% transmission (i.e. 1/10^{th} of the full illumination intensity), ND20=5% transmission ( 1/20^{th}), and so on. Large ND values were obtained by combining filters in series, with the aggregate values shown. For example, ND10+ND100 would be listed as ND1000 ( 1/1000^{th}, 0.1% transmission). Further details of the filters used are presented below in Table 3:

TABLE 3

| Filter Set | Color | Excitation | DM | Emission | Fluorochromes |
|---|---|---|---|---|---|
| DAPI | Blue | 330-380 | 400 | 435-485 | DAPI, HO |
| UV-2E/C | Blue | 340-380 | 400 | 435-485 | DAPI, HO |
| B-2E/C | Green | 465-495 | 505 | 515-555 | FITC |
| (FITC) | | | | | |
| EN GFP | Green | 450-490 | 495 | 500-550 | GFP |
| G-2E/C | Red | 528-553 | 565 | 600-660 | Mito |
| (TRITC) | | | | | |
| HYQ Cy5 | FR | 590-650 | 660 | 663-735 | Cy5, DiD |
| 780DCXR | NIR | 667-742 | 780 | 780LP | DiR |

Excitation, DM, and Emission values are in nanometers (nm).
DM, dichroic mirror;
FR, far-red;
NIR, near infrared;
LP, long pass.
All filter sets except 780DCXR were manufactured by Nikon. 780DCXR is a custom filter set manufactured by Chroma Technology.
DAPI and UV-2E/C sets were used interchangeably.

Photography, Photomicrography, Cameras, Image Processing

Comparisons of images visible by eye through standard microscope eyepieces and images visible with the aid of the NIRIC were made by comparing direct photomicrographs with photographs of the output phosphor face of the image intensifier. Film photography was used as a stand-in for human vision because film's response is specifically tailored to visible wavelengths of light. Differences between film and human vision in terms of sensitivity and dynamic range can be partially compensated for by controlling exposure time during photography. These measures are not quantitative, and photographs were chosen to convey what was visible when specimens were observed by eye, as judged by several individuals. Kodak ELITE Chrome 400 color slide film was used for all 35 mm film photography; its spectral sensitivity is essentially limited to the range between 400 and 700 nm [Kodak Publication No. E-149 (1998)]. Various Nikon SLR camera bodies and lenses were used for studio and lab photography. A MicroNikkor 60 mm macro lens was used to photograph the NIRIC's output phosphor face. Photomicrographs from both the E800 and TE200 microscopes were taken with a Nikon U-III automatic photo system.

Photodocumentation of images from the NIRIC's output phosphor was performed using a 35 mm single lens reflex (SLR) camera (with a lock-up mirror) and a 60 mm macro lens, using a tripod. The eyepiece and cap of the NIRIC's shell were removed, and the SLR aimed at the NIRIC output phosphor from directly above. Pictures were taken in a totally darkened room. The macro lens was focused so as to fill the film frame (nominally 24×36 mm) with the image of the NIRIC's phosphor face (25 mm diameter); the resulting images were essentially actual size.

Direct photomicrography was performed with a Nikon U-III 35 mm automatic photo system. In all cases, microscope beamsplitters were used to send equal amounts of light to the NIRIC and the U-III. Photographs from the NIRIC and the U-III were taken simultaneously, with the NIRIC at the ‘third eyepiece’ position and the U-III at the secondary camera port. Microscope intermediate image magnifications to both devices were exactly matched with the use of identical Nikon PLI 2.5× projection lenses. To accommodate the focal distance of the projection lens, a custom phototube was made for the NIRIC. The assembly (projection lens, phototube, coupler, NIRIC) was parfocal with both the U-III system (projection lens and phototube) and the microscope eyepieces. Kodak ELITE Chrome 400 color slide film was also used for all photography with the U-III.

Except in cases where fields of view (FOV) were explicitly compared, photographs were cropped to the FOV of the NIRIC. FOV measurements were made with a calibrated stage micrometer. Developed film was digitized by scanning with a Nikon LS-2000 film scanner at 12 bits per color channel (RGB) and an optical resolution of 2700 pixels per inch. Images were stored in the lossless Tagged Image File Format (TIFF, 16 bit files). Digital images were captured with a Princeton Instruments MicroMax CCD camera (model RTE/CCD-1300-Y/HS, Roper Scientific, Trenton, N.J.) using MetaMorph imaging software (Universal Imaging, Downingtown, Pa.).

Fluorescent Stains and Dyes

Hoechst 33258 (HO), MitoTracker Red CM-H₂XRos (Mito), Vybrant DiD (DiD), and DiR were all obtained from Molecular Probes (Eugene, Oreg.). With the exception of DiR, these were used essentially as recommended by the manufacturer. DiR was dissolved in pure anhydrous ethanol to 1 mg/mL, and then used according to the guidelines for Vybrant DiD.

In Vitro Live Cell Staining

The production and culture of human embryoid body-derived (EBD) cells expressing green fluorescent protein (GFP-EBD cells) has been described [Shamblott, et al. (2001) Proc Natl Acad Sci USA 98:113-8.]. To stain GFP-EBD cells for photography, HO, Mito, DiD, and DiR were simultaneously added to fresh, prewarmed EGM2MV media (Clonetics, San Diego, Calif.) and mixed to make staining medium. Normal culture medium was removed and replaced by this staining medium; cells were then returned to the incubator and stained for two hours. Cells were then rinsed five times with prewarmed Dulbecco's phosphate buffered saline (DPBS, Life Technologies, Rockville, Md.) to remove excess stain. The final wash was removed and replaced with prewarmed DMEM without phenol red (Life Technologies, Carlsbad, Calif.) or with prewarmed DPBS, both containing 5% fetal calf serum (FCS), 20 mM lactate, and 20 μL/ml OxyFluor (Oxyrase, Inc., Mansfield, Ohio) to reduce photobleaching. The tissue culture dish was sealed to prevent gas exchange, and cells were returned to the incubator for 30 minutes. The dish was then removed from the incubator and photographed on the TE200 inverted microscope.

Injection of Cells into Mouse Spleen, Cryosectioning

Human EBD cells [Shamblott, et al. (2001) Proc Natl Acad Sci USA 98:113-8] were labeled with DiR, trypsinized, and washed three times in DPBS without Ca²⁺ or Mg²⁺ (Life Technologies) to remove unincorporated dye. 1×10⁵ labeled cells in 100 μL DPBS were injected into cadaveric mouse spleens through a 27G butterfly needle. Spleens were then fixed in 4% paraformaldehyde (Electron Microscopy Sciences, Fort Washington, Pa.) in DPBS at 4° C. overnight. After fixation, spleens were transferred into 30% sucrose and incubated overnight at 4° C., and then placed in O.C.T. compound (Tissue-Tek, Sakura, Torrance, Calif.) and frozen (at −80° C. in 2-methylbutane). Eight micron sections were cut on a cryostat (Microm, Richard-Allan Scientific, Kalamazoo, Mich.) and transferred to glass slides. Slides were stored at −20° C. until examined.

Fluorescent In Situ Hybridization (FISH)

WAV-17 cells have been described [Patterson (1998); Slate and Ruddle (1978) Cytogenet Cell Genet 22:270-4; Raziuddin, et al. (1984) Proc Natl Acad Sci USA 81:5504-8.], and were grown in DMEM containing 15% FCS, 0.10 non-essential amino acids, 100 units/mL penicillin and 100 mg/mL streptomycin (Life Technologies), at 37° C., 90% humidity, in a 5% CO2 atmosphere. Metaphase spreads were made as follows: Rapidly growing WAV-17 cells were incubated in colcemid (0.1 mg/mL, added to culture media, KaryoMax, Life Technologies) for 20 minutes, and cells arrested in metaphase were dislodged by sharply striking the culture dish. Arrested cells were collected, pelleted, and resuspended in 75 mM KCl and incubated at 37° C. for 35 minutes. The cells were then fixed in 3:1 methanol/acetic acid. Fixed cells were dropped onto glass slides in a controlled humidity chamber, and allowed to dry. Slides were stored at −20° C. until used for FISH.

To synthesize probes for FISH, human placental DNA (Sigma, St. Louis, Mo.) was biotinylated using a BioNick kit (Life Technologies) according to the manufacturer's instructions. Probes were stored at −20° C. until used for FISH. FISH was carried out as follows: WAV-17 metaphase spread slides were aged in 2×SSC, dehydrated in ethanol, and air-dried. 100 ng of biotinylated human placental DNA probe in 12 mL of 50% formamide/2×SSC per slide was sealed under a coverslip, and the slide and probe denatured (75° C., 6 minutes) and then hybridized (37° C., overnight). Slides were washed to a final stringency of 2×SSC at room temperature. Hybridized probe was detected with fluorescein-avidin DN (Vector Labs, Burlingame, Calif.) or Fluorolink Cy5-labeled streptavidin (Amersham-Pharmacia Biotech, Piscataway, N.J.) and biotinylated anti-avidin D antibody (Vector Labs) in 4×SSC containing 0.05% Tween-20 and 5% non-fat dry milk as blocking agent. Chromosomes were counterstained with DAPI Molecular Probes), and the slides mounted with Prolong antifade reagent (Molecular Probes). Slides were examined on the E800 microscope with a 100× objective using Cargille Type FF immersion oil.

Embryos

Mouse embryos at various stages of development were maintained in droplets of M16 medium [Hogan, et al. (1994) Manipulating the Mouse Embryo: A Laboratory Manual, 2^{nd} edition, Cold Spring Harbor Laboratory Press, Plainview, N.Y.] under oil at 37° C. in a 5% CO₂ atmosphere.

Fluorescence Intensity Standards

SPHERO Rainbow Calibration Particles were obtained from Spherotech, Inc. (Libertyville, Ill.). The set (RCP-30-5A-1-8, highly concentrated stocks) is intended for use in flow cytometers, and consists of 3 μm polystyrene beads of eight different fluorescence intensities. The beads are calibrated in units of molecules of equivalent fluorophore (MEF) [Gaigalas (2001) Journal of Research of the National Institute of Standards and Technology 106:381-389.], covering four orders of magnitude in intensity.

An ordered intensity array was constructed by micromanipulation as follows: 50 μL of beads were pelleted by a short spin in a microfuge, washed once in 50 μL of water, and pelleted again. The supernatant was removed, and the beads resuspended in 2-5 μL of 30% sucrose (w/v in water). This wash procedure was carried out separately for each of the eight kinds of beads in the set. Standard #1 glass coverslips were washed once in isopropanol, once in 100% ethanol, and once m water, and then aspirated dry. A washed coverslip was placed on a glass slide held on the stage of the TE200 inverted microscope, which was equipped with a micromanipulator (Narishige, Tokyo, Japan) that controlled a glass micropipette (12-15 μm inner diameter). A drop (1 μL) of beads in 30% sucrose was deposited near the edge of the coverslip, and the tip of the micropipette lowered into the drop, allowing the bead/sucrose suspension to front-fill the micropipette by capillary action.

The tip of the micropipette was adjusted to be in contact with the surface of the coverslip, and the filled micropipette was then used as a pen to write a line of beads in sucrose across the coverslip by linear movement of the microscope stage. This was repeated for all eight kinds of beads, resulting in a closely spaced linear array that progressed from the brightest to the dimmest beads. The coverslip was allowed to air dry overnight in the dark, immobilizing the beads in sucrose. The coverslip was then mounted on a glass slide, bead side down, using a drop of Cargille Type FF immersion oil (Cargille, Cedar Grove, N.J.) as mounting medium. The edges of the coverslip were left unsealed, and the arrays stored at room temperature in the dark. The sucrose lines of the array were stable for approximately one week, after which neighboring lines began to intermix.

### EXAMPLE 1

### NIRIC Construction, Background, and Field of View

The NIRIC and coupler was disposed in the ‘third eyepiece’ position on the E800 microscope. The output phosphor of the NIRIC is a monochrome green; therefore the output image is always green regardless of the spectral content of the intermediate image at the intensifier's input optic. When the NIRIC is switched on there is a 1-2 second delay before the intensifier's output phosphor becomes active. When switched on but not exposed to light, the NIRIC displays sparse, pinpoint, rapidly changing random signals very similar to the noise (‘snow’) typically seen with CCD and video cameras. The noise level increases slightly as the intensifier tube heats up with use, but is generally so dim that it is negligible. Measurements with a stage micrometer showed that the field of view provided by the NIRIC in ‘third eyepiece’ configuration was identical to the view through the microscope's normal eyepieces for both the E800 and TE200 microscopes.

### EXAMPLE 2

### Spectral Performance and Visualization of Far-Red and NIR Fluorescence

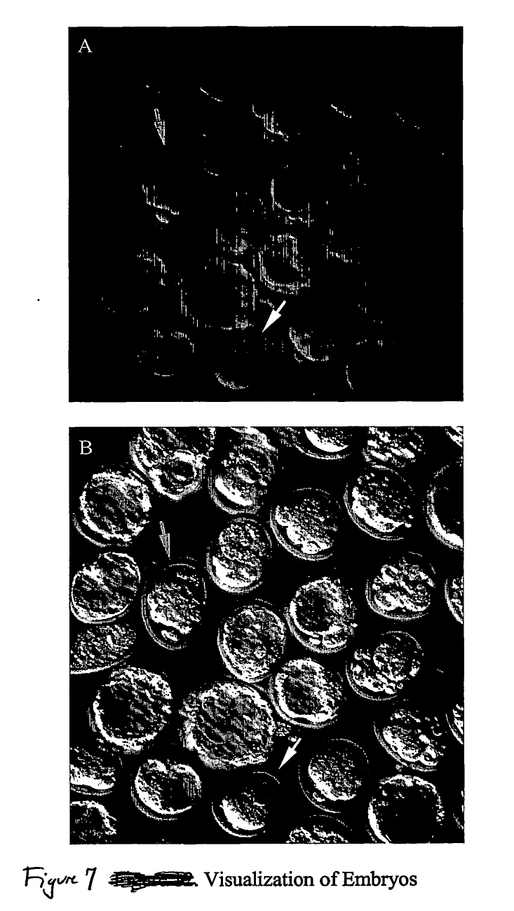

The NIRIC was tested across its operational range (450-900 nm) by imaging live cells stained with a series of fluorescent dyes. Human embryoid body-derived cells constitutively expressing high levels of green fluorescent protein (GFP-EBD cells), were simultaneously stained with Hoechst 33258 (HO, a membrane-permeant DNA dye), MitoTracker Red CM-H2XRos (Mito, stains active mitochondria), and the lipophilic dyes DiD and DiR. DiD has spectral characteristics very similar to those of Cy5; DiR fluorescence lies in the NIR and has no visible component. Quintuply-labeled cells were imaged with an ELWD 60×, NA 0.70 HMC objective on the TE200 inverted microscope, with full illumination from a 100-watt mercury arc lamp as the excitation source. Results are shown in FIG. 5.

The blue fluorescence from HO-stained nuclei was so strong that it was detected by the NIRIC even though the vast majority of HO fluorescence emissions are below the operating range of the NIRIC intensifier tube. Although blue signals are detected, the NIRIC does not appear to amplify them. In green (GFP), and to a greater extent in red (Mito), signal amplification through the NIRIC was apparent. Amplification was accompanied by a noticeable loss of resolution in the observed image, consistent with saturation of the intensifier tube. In the far-red (DiD), very little was visible by eye through the microscope's standard eyepieces, but strong, specific cell staining was clearly seen using the NIRIC. In the NIR (DiR), the field was completely dark when observed through the microscope's standard eyepieces, but cells stained with DiR were easily visible through the NIRIC. Sharp punctate staining was typical for cells stained with DiD and DiR; these dyes appear to be rapidly internalized from the plasma membrane and concentrated in endosomes or lysosomes. We noted an almost total absence of background fluorescence in NIRIC images in the far-red and NIR compared to background levels at shorter wavelengths. These results demonstrate that the NIRIC allows the direct visualization of fluorescence emissions at wavelengths normally undetectable with the naked eye.

### EXAMPLE 3

### Visual Scanning of Tissue Sections

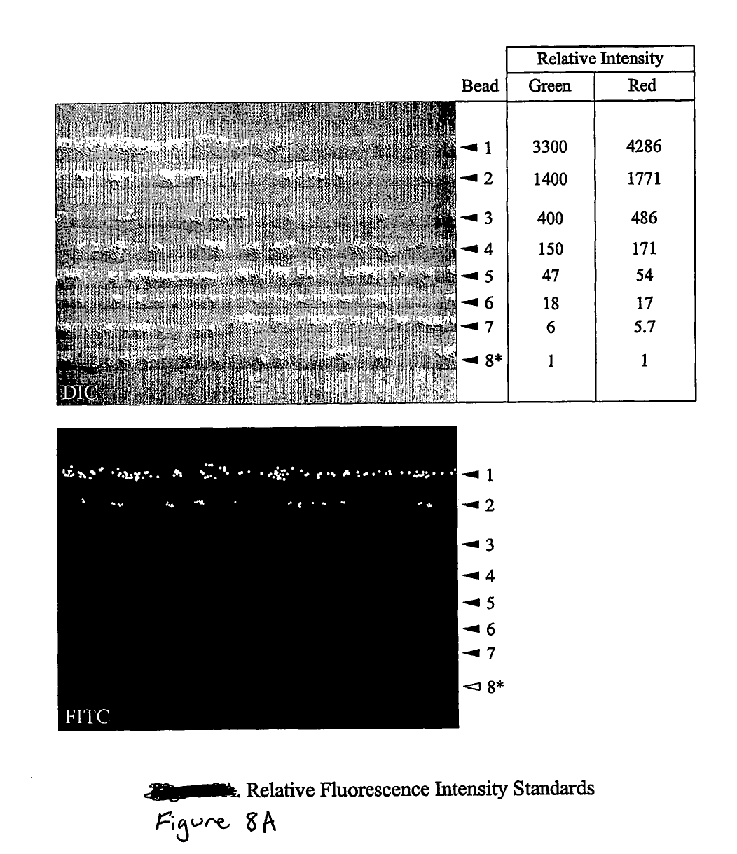

The NRIC was used to locate small numbers of fluorescently labeled cells in tissue sections. FIGS. 6A-6D demonstrate the successful use of the NIRIC in streamlining this screening process. DiR-labeled human EBD cells were injected into mouse spleens. The spleens were then processed for cryosectioning, and examined under epifluorescence on the E800 microscope.

With the NIRIC in ‘third eyepiece’ position, sections were scanned at low power using a 10×, NA 0.30 phase objective. Several widely separated clusters of bright DiR-labeled cells were clearly visible through the NIRIC in the section shown in FIG. 6A. Attempts to image these cells with the MicroMax CCD camera were not successful, even with long exposures. In order to compensate for the CCD camera's low sensitivity at DiR emission wavelengths, the section was indirectly scanned using a 20×, NA 0.50 objective. Under these conditions, DiR-labeled cells were imaged by the CCD camera, but more than 35 digital frames would be required to survey the field visible at 10× through the NIRIC. FIG. 6B shows the field presented by the NIRIC at 10×, overlaid by a grid showing some of the individual frames captured by the CCD camera at 20×. All of the empty frames in the grid can be avoided with the aid of the NIRIC, since large areas can be scanned in real time, necessitating only a few long exposure images from the CCD camera for documentation.

### EXAMPLE 4

### Visualization of Embryos with Minimal Illumination

The photosensitivity of embryos has been noted for some time [Daniel (1964) Nature 201:316-317; Hirao and Yanagimachi (1978) J Exp Zool 206:365-9; Hegele-Hartung et al. (1991) Anat Embryol 183:559-71; Squirrell, et al. (1999) Nat Biotechnol 17:763-7.], and has significant implications for many areas of basic and clinical research, including studies of development and differentiation, transgenesis, and in vitro fertilization (IVF). To limit phototoxicity, investigators typically illuminate embryos with longer wavelengths of light. This may entail observation of embryos and cells under red light [Daniel (1964) Nature 201:316-317; Hirao and Yanagimachi (1978) J Exp Zool 206:365-9; Squirrell, et al. (1999) Nat Biotechnol 17:763-7.], or the application of multi-photon fluorescence techniques [Squirrell, et al. (1999) Nat Biotechnol 17:763-7.]. However, multi-photon techniques require high excitation energies that are potentially damaging, and there is evidence that even long wavelength light is harmful to living tissues [Potter (1996) Curr Biol 6:1595-8; Konig (2000) J Microsc 200:83-104; Tirlapur, et al. (2001) Exp Cell Res 263:88-97.].

The NIRIC incorporates an image intensifier 170, and thereby provides a simple and direct way to reduce phototoxicity in sensitive specimens by allowing observation with greatly reduced illumination intensities in both transmitted light and fluorescence techniques. To qualitatively assess the NIRIC's performance in low-light brightfield applications we observed mouse embryos on the TE200 microscope by HMC microscopy (transmitted light) using a 40×, NA 0.60 objective. Illumination intensity was controlled by reducing the operating voltage of the microscope's tungsten bulb.

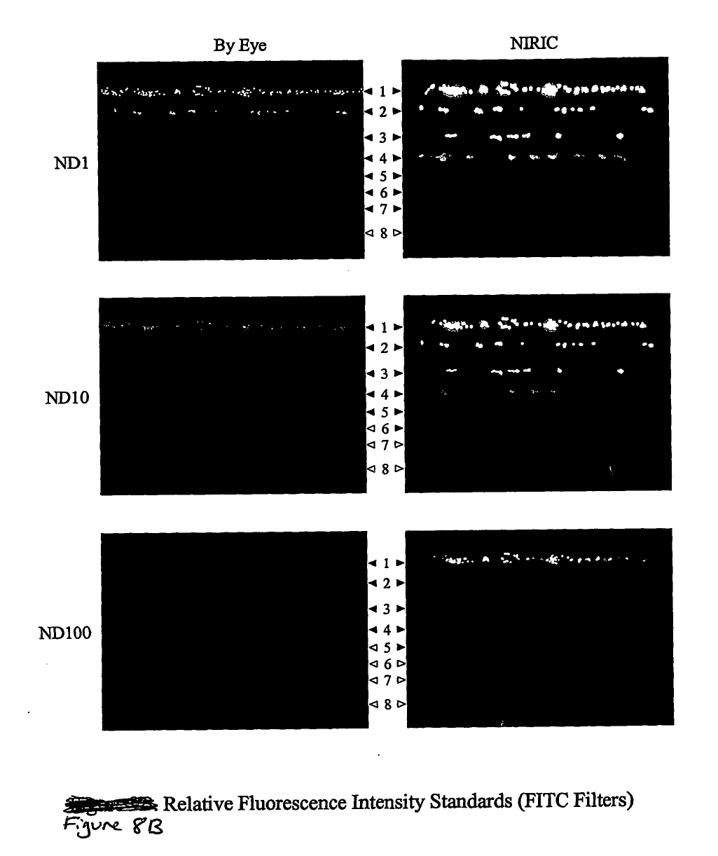

With the NIRIC, embryos could be seen clearly at illumination levels that were insufficient for visualization by eye through standard eyepieces. The NIRIC conveyed focusing and stage movements in real time and without artifacting. FIGS. 7A-7B shows the embryos as seen through the NIRIC at low light levels (FIG. 7A), and as seen by eye at higher illumination levels (FIG. 7B, as photographed with the U-III camera). There was a slight degradation of image quality when the embryos were viewed through the NIRIC (compare images at red and white arrows). However, we found the clarity and resolution of the NIRIC image sufficient for the vast majority of applications, including micromanipulation.

### EXAMPLE 5

### Epifluorescence Microscopy with Drastically Reduced Excitation Light

To gauge the sensitivity of the NIRIC in epifluorescence applications, we adapted FACS intensity standards for use with the E800 epifluorescence microscope. A linear array of fluorescently labeled beads was made as described in Materials and Methods. The beads' fluorescence intensities are calibrated in units of Molecules of Equivalent Fluorophore (MEF) [Gaigalas (2001) Journal of Research of the National Institute of Standards and Technology 106:381-389.], however we did not attempt to use these values in our measurements. Instead of measuring the actual intensity of the standard, we assessed the minimum amount of excitation light required to visualize the standards. This approach is relevant in the following way: the most effective way to reduce photobleaching or phototoxicity during fluorescence observations is to limit exposure to excitation light, either by minimizing the time the specimen is illuminated or by reducing the intensity of the excitation light. These measures have disadvantages—limiting illumination time precludes extended observations, and limiting illumination intensity can obscure subtle or dim fluorescent signals. Visualization through the NRIC allows reduction of illumination intensity without these associated disadvantages. Our measurement indicates how little excitation light is sufficient to illuminate a specimen observed through the NIRIC.

All sensitivity measurements were carried out on the E800 microscope. A 20×, NA 0.50 objective was used to include all eight array lines in the same field of view. The array was observed through TRITC fluorescence filters. Excitation light from a 100-watt mercury arc lamp was considered full illumination, and all comparisons refer to this illumination level. Excitation light was attenuated with a series of neutral density filters placed between the mercury source and the fluorescence filters. Large ND values were obtained by combining filters. Three observers judged which beads were visible at each illumination level.

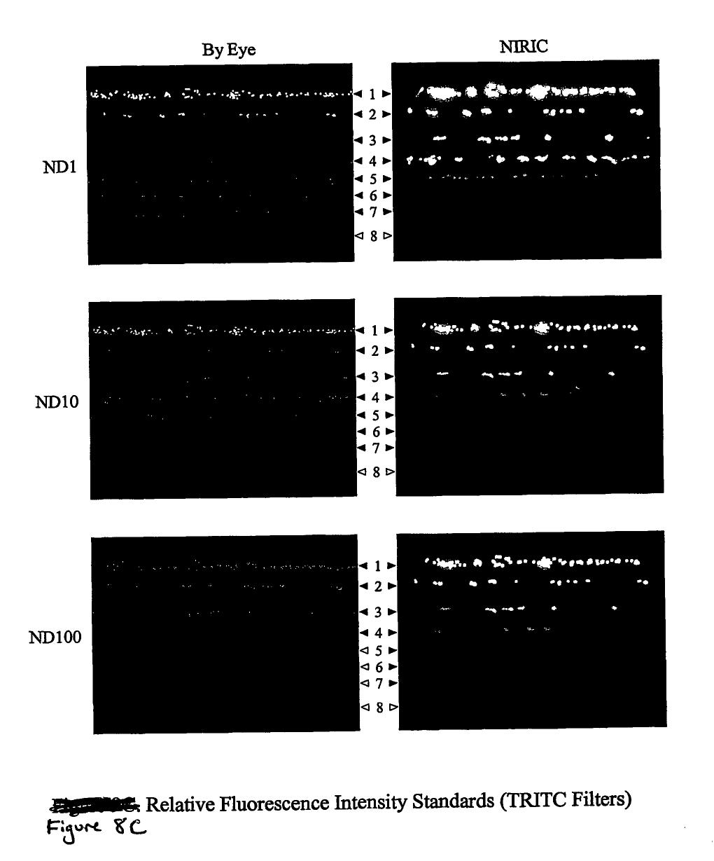

The beads and their immobilizing sucrose lines were all visible by DIC brightfield microscopy (FIG. 8A, top). The beads are numbered 1 through 8 (brightest to dimmest, respectively), and their relative brightness is indicated. For reference, calibrated MEF values (for equivalent phycoerythrin) are also listed. Beads in group 8 were unlabeled (nonfluorescent), and represent background controls. The group 8 controls and the sucrose lines were not visible during epifluorescence observations. For reference, calibrated MEF values are listed below in Table 4.

TABLE 4

Relative Fluorescence
Intensity

| Bead | Green | Red | MEFL | MEPE |
|---|---|---|---|---|
| 1 | 3300 | 4286 | 330,000 | 300,000 |
| 2 | 1400 | 1771 | 140,000 | 124,000 |
| 3 | 400 | 486 | 40,000 | 34,000 |
| 4 | 150 | 171 | 15,000 | 12,000 |
| 5 | 47 | 54 | 4700 | 3800 |
| 6 | 18 | 17 | 1800 | 1200 |
| 7 | 6 | 5.7 | 600 | 400 |
| 8* | 1 | 1 | 100 | 70 |

Bead 8 is unlabeled (no fluorochromes);
Intensities are relative to the background fluorescence of Bead 8, when viewed in green (FITC filters) and red (TRITC filters).
Calibrated intensity values for FACS:
MEFL, molecules of equivalent fluorescein;
MEPE, molecules of equivalent phycoerythrin.

FIG. 8B shows results obtained with decreasing illumination intensity for green emissions (FITC filters), and FIG. 8C shows results for red emissions (TRITC filters). Under full epifluorescence illumination, all seven labeled beads were visible by eye and through the NIRIC (ND1). Pronounced halo and other artifacting of bright beads were produced by the NIRIC under strong illumination. With a one hundred-fold reduction of excitation light, only the four brightest beads remained visible by eye, while all seven labeled beads were still visible through the NIRIC (ND100). Table 5 summarizes the results at greater attenuation levels. At ND10000 none of the beads were visible by eye, while the NIRIC rendered the four brightest beads visible at ND40000, and the two brightest beads visible at ND100000. These results clearly demonstrate that the NIRIC can be used to facilitate prolonged fluorescence observations and minimize photobleaching and phototoxicity by drastically reducing the amount of excitation light required to visualize specimens.

TABLE 5

| | Beads visible in Green | | Beads visible in Red | |
|---|---|---|---|---|
| | (corresponding to FIG. 8B) | | (Corresponding to FIG. 8C) | |
| ND | By Eye | NIRIC | By Eye | NIRIC |
| 1 | 1, 2, 3, 4, | 1, 2, 3, 4, | 1, 2, 3, 4, | 1, 2, 3, 4, |
| | 5, 6, 7 | 5, 6, 7 | 5, 6, 7 | 5, 6, 7 |
| 10 | 1, 2, 3, 4, 5 | 1, 2, 3, 4, 5, 6 | 1, 2, 3, 4, | 1, 2, 3, 4, |
| | | | 5, 6, 7 | 5, 6, 7 |
| 100 | 1, 2, 3, 4 | 1, 2, 3, 4, 5 | 1, 2, 3, 4 | 1, 2, 3, 4, |
| | | | | 5, 6, 7 |
| 1000 | 1, 2 | 1, 2, 3, 4 | 1, 2 | 1, 2, 3, 4, |
| | | | | 5, 6 |
| 10000 | 1 | 1, 2 | — | 1, 2, 3, 4 |
| 20000 | — | 1 | — | 1, 2, 3, 4 |
| 40000 | — | 1 | — | 1, 2, 3, 4 |
| 80000 | — | — | — | 1, 2, 3 |
| 100000 | — | — | — | 1, 2 |

The table indicates which beads in the Relative Fluorescence Intensity Standard Array are visible through standard microscope eyepieces (By Eye) or with the NIRIC at decreasing levels of epifluorescence illumination (i.e., increasing attenuation by neutral density filters).
Green = FITC filters,
Red = TRITC filters;
ND = neutral density.
ND1, full illumination (no attenuation, 100 watt mercury arc lamp source);
ND10, 10% transmission (i.e., 1/10^{th} of the full illumination intensity);
ND100, 1% transmission, and so on.

### EXAMPLE 6

### Visualization of Far-Red Fluorescence in Fluorescent In Situ Hybridization

Cy 5 and other long wavelength-emitting fluorochromes are widely employed as labels in multicolor fluorescent in situ hybridization (FISH) experiments because their emissions can be easily separated from the emissions of visible spectrum fluorochromes. However, their use mandates indirect visualization of hybridization signals, usually with a CCD camera As mentioned previously, this process is often tedious and time-consuming.

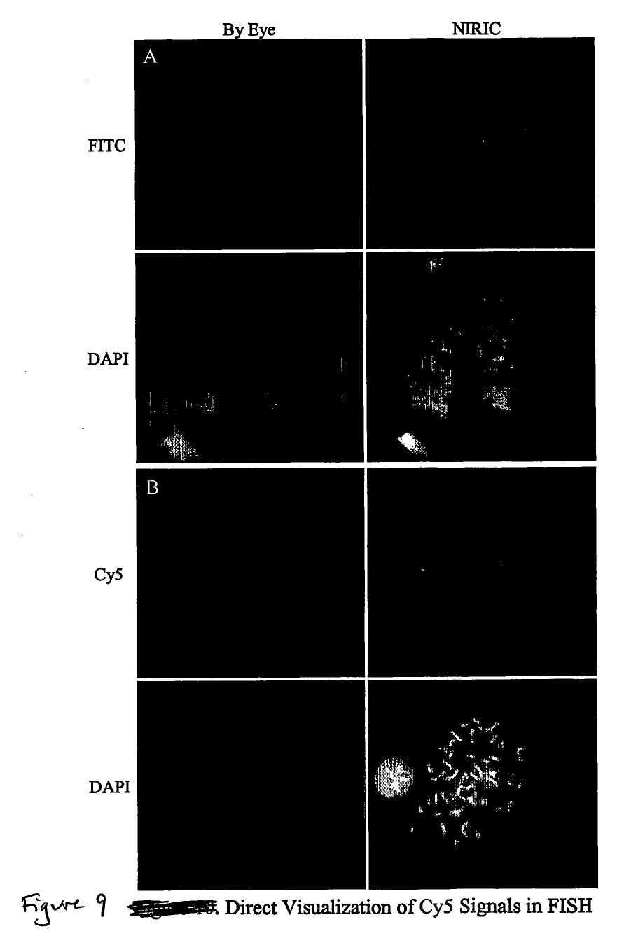

The NIRIC was used to directly visualize fluorescent signals from a Cy5-labeled FISH probe hybridized to metaphase chromosomes. WAV-17 cells [Patterson (1998); Slate and Ruddle (1978) Cytogenet Cell Genet 22:270-4; Raziuddin, et al. (1984) Proc Natl Acad Sci USA 81:5504-8.] are hyperdiploid mouse-human hybrids that carry an average of three copies of human chromosome 21 as the only human genetic material (cells may carry as few as two or as many as five copies). Total human genomic DNA was biotinylated and used as a FISH probe against WAV-17 metaphase chromosomes. Probe hybridization to human chromosome 21 was detected with FITC-labeled avidin or Cy5-labeled streptavidin. Metaphase chromosomes were then examined on the E800 microscope using a 100× oil immersion objective. The NIRIC enhanced the visibility of dim FITC signals (FIG. 9A), and allowed the direct visualization of Cy5 signals that cannot be seen through standard eyepieces (FIG. 9B). Visualization with the NIRIC was accomplished in real-time, and large numbers of metaphase spreads were quickly scanned and examined. It should be noted that the NIRIC cannot compensate for poor contrast (or poor signal-to-noise ratio) in specimens. Signals from background fluorescence and nonspecific staining of mouse chromosomes are intensified along with specific hybridization signals, and cannot be subtracted from the output image as is possible with CCD cameras.

Our results demonstrate that use of electro-optical image intensifying devices such as night vision image intensification devices can be practically and effectively applied to optical microscopy. The NIRIC tested successfully met all design goals: its use required no modifications to the test microscopes, allowed real-time observation and visual scanning, and did not restrict the observed field of view. The NIRIC can be used to visualize any transmitted light or fluorescence emission that falls within its operating range (450-900 nm). By converting far-red and NIR light into green light, the NIRIC allows the direct visualization of long wavelength-emitting fluorophores whose signals are normally invisible to the naked eye. Due to its high sensitivity, the NIRIC makes visualization possible under drastically reduced illumination levels in both transmitted light and epifluorescence techniques, thereby reducing photobleaching and phototoxicity. Because the NIRIC allows visualization in real time, it can be used to observe rapid phenomena and motion (e.g., during micromanipulation), and to quickly scan various specimens.

It should be recognized that the results reported herein significantly underestimate the NIRIC's performance. During the testing of the NIRIC's sensitivity, the dimensions of the fluorescent bead array required the use of an objective with limited light-gathering ability (20×, NA 0.50). Tests with higher power, higher NA objectives showed that the NIRIC could operate with far less illumination than indicated by Table 1. Furthermore, the objectives used during testing contained phase rings or were modified for HMC microscopy, reducing the amount of light conducted to the NIRIC. Lastly, the figures of tthe images of the NIRIC's output phosphor screen were recorded without the benefit of secondary magnification provided by the 10× eyepiece, and therefore show a fraction of the detail as would have been seen by an observer. The images shown here are also less resolved than those seen by an observer looking through the NIRIC's eyepiece because they have been focused twice—once by the microscope onto the intensifier tube's input face, and a second time by the macro lens of the SLR camera used for documentation.

Although the shell and other coupling hardware described here fit the NIRIC onto Nikon infinity-corrected microscopes, the NIRCI and its design principles can be extended to any microscope whose intermediate image can be focused onto the input optic of an image intensifier tube. Even techniques requiring stereoscopy can be accommodated, if two devices can be arranged in a binocular configuration. The NIRIC can also be modified for use with blue-emitting fluorophores by incorporating an intensifier tube with increased sensitivity at short visible wavelengths. Such ‘high-blue’ tubes are becoming available, and if applied could drastically reduce damage and phototoxicity that is associated with ultraviolet and violet illumination.

In summary, the method, devices and systems of the present invention advantageously allow the direct visualization by eye of normally invisible, long-wavelength fluorescence through an optical microscope and also allow visualization of a wide variety of specimens at greatly reduced illumination levels, regardless of the microscopic technique involved. Further the results herein with the described examples indicate the flexibility and potential of the device—by allowing an observer to see in the dark, it expands the list of observable fluorophores and shields fragile specimens.

Although a preferred embodiments of the method, devices and systems of the present invention have been described using specific terms, such description is for illustrative purposes only, and it is to be understood that changes and variations may be made without departing from the spirit or scope of the following claims.

What is claimed:

1. A method for microscopic visualization of a sample comprising:
(a) intensifying the light emanating from the sample; and
(b) directly observing a light image provided by the intensified light.

2. The method of claim 1, wherein said light intensifying and observing occurs in real time.

3. The method of any one of claims 1 or 2, further comprising the step of controlling the power output of an illumination source to a desired intensity.

4. The method of claim 3, wherein the desired intensity is such that light emanating from the sample is not optimal for direct visual observation, and wherein said intensifying the light yields a visible image that is observable to the human eye.

5. The method of any one of claims 1-4, further comprising converting the light that is emanating from the sample in non-visible wavelengths of light to light that is in the visible light spectrum.

6. The method of claim 5, wherein said observing includes observing the light image provided by the converted intensified light.

7. The method of any one of claims 5 or 6, wherein the non-visible light is in one of a near-infrared spectral range or a far-red spectral range.

8. The method of any one of claims 5 or 6, wherein the non-visible light is in the ultraviolet spectral range.

9. The method of any one of claims 1-8, further comprising providing an visual converter that is configured and arranged so as to intensify the light received at an input end and to provide an image at an output end and wherein said observing includes observing the image at the output end.

10. The method of claim 9, wherein the visual converter is located in the optical light path between the sample and an observer such that the light from the sample is received at the visual converter input end.

11. The method of any one of claims 9 or 10, wherein the visual converter is located so that an input face of a light intensifying device is one of at or proximal the intermediate image plane of the microscopic imaging device.

12. The method of any of any of claims 9-11, further providing a plurality of the visual converters, one visual converter being located in each optical light path so as to allow stereoscopic imaging.

13. The method of claim 12, wherein the plurality of the visual converters are arranged so as to allow binocular vision of the intensified light.

14. The method of any one of claims 9-13, wherein the visual converter is configured and arranged such that light being received at the input end is intensified so as to provide a visible image at the output end thereof.

15. The method of claim 14, further comprising the step of controlling the power output of an illumination source to a desired intensity.

16. The method of claim 15, wherein the desired intensity is such that light emanating from the sample is not optimal for direct visual observation, and wherein said intensifying the light yields a visible image that is observable to the human eye.

17. The method of any one of claims 9-16, wherein the visual converter is configured and arranged so that light being received at the input end that is in a non-visible light spectral range is converted to provide a light image that is in the visible light spectral range at the output end thereof.

18. The method of claim 17, wherein the non-visible light is in one of a near-infrared spectral range or a far-red spectral range.

19. The method of claim 17, wherein the non-visible light is in a ultraviolet spectral range.

20. An visual converter device comprising:
(a) an electro-optical device that is sensitive to light in a wavelength range of interest and configured to intensify light in the wavelength range of interest focused on its input face to an image that can be directly visualized at the output face thereof; and
(b) a housing in which the electro-optical device is contained, which housing is configured and arranged to operably couple the visual converter to a microscopic imaging device and to minimize external stray light from being observed at the output face of the electro-optical device.

21. The visual converter device of claim 20, wherein said electro-optical device intensifies the light that is focused on its input face to light that is in the visible light spectral range.

22. The visual converter device of claim 21, wherein the power output of an illumination source is controlled to a desired intensity.

23. The visual converter device of claim 22, wherein the desired intensity is such that light emanating from the sample is not optimal for direct visual observation, and wherein said intensifying the light yields a visible image that is observable to the human eye.

24. The visual converter device of any of claims 20-23, wherein said electro-optical device converts the light that is focused on its input face in non-visible light spectral ranges to light that is in the visible light spectral range.

25. The visual converter device of claim 24, wherein the non-visible light is in one of a near-infrared spectral range or a far-red spectral range.

26. The visual converter device of claim 24, wherein the non-visible light is in a ultraviolet spectral range.

27. A microscopic imaging system comprising:
(a) a microscopic imaging device; and
(b) a visual converter device of any one of claims 20-26 operably coupled to the microscopic imaging device, wherein the visual converter device is located in the optical light path between the sample and an output end of the microscopic imaging device, such that the light from the sample is received at the visual converter input end.

28. The microscopic imaging system of claim 27, wherein the visual converter device is located so that the input face of the light intensifying device is one of at or proximal to the intermediate image plane of the microscopic imaging device.

29. The microscopic imaging system of any one of claims 27-28, further providing a plurality of the visual converters, one visual converter being located in each optical light path so as to allow stereoscopic imaging.

30. The microscopic imaging system of claim 29, wherein the plurality of the visual converters are arranged so as to allow binocular vision of the intensified light.

31. The microscopic imaging system of any one of claims 29 or 30, wherein said electro-optical device intensifies the light that is focused on its input face to light that is in the visible light range.

32. The microscopic imaging system of claim 31, wherein the power output of an illumination source is controlled to a desired intensity.

33. The microscopic imaging system of claim 32, wherein the desired intensity is such that light emanating from the sample is not optimal for direct visual observation, and wherein said intensifying the light yields a visible image that is observable to the human eye.

34. The microscopic imaging system of any one of claims 28-33, wherein the visual converter is configured and arranged such that light being received at the input end that is in a non-visible light spectral range is converted so as to provide a visible image at the output end thereof.

35. The microscopic imaging system of claim 34, wherein the non-visible light is in one of a near-infrared spectral range or a far-red spectral range.

36. The microscopic imaging system of claim 34, wherein the non-visible light is in an ultraviolet spectral range.
